(19) United States
(12) Patent Application Publication
(10) Pub. No.: US 2003/0033216 A1
(43) Pub. Date: Feb. 13, 2003

(54) System and method for providing real time pricing based on variables

(76) Inventor: Moshe Benshemesh, London (GB)

Correspondence Address: PROCOPIO, CORY, HARGREAVES & SAVITCH LLP, 530B STREET, SUITE 2100, SAN DIEGO, CA, 92101, US

(21) Appl. No.: 10/216,309

(22) Filed: Aug. 9, 2002

Related U.S. Application Data
(60) Provisional application No. 60/311,333, filed on Aug. 10, 2001.

(51) Int. Cl. G06F 17/60

(52) U.S. Cl. 705/26

(57) ABSTRACT

Disclosed is a system and method for buyers and sellers to conduct business by utilizing an electronic marketplace. The method includes the buyer establishing an account with a service provider by providing information, assigning a fee structure and trade limit to the buyer for future purchases made based on predetermined criteria, the buyer accepting the fee structure, storing the buyer's account information, including the fee structure, the buyer viewing a seller's electronic catalog which is either general or specific to the buyer, the buyer making selections of goods or services to purchase from the seller's electronic catalog, the buyer selecting payment terms for the goods or services selected, service provider or guarantor paying seller a net price for goods or services ordered by the buyer, and the buyer paying the service provider or guarantor a gross price for the goods or services ordered by the buyer.

This application is a utility patent application that claims the benefit of U.S. patent application Ser. No. 60/311,333 filed on Aug. 10, 2001, entitled SYSTEM AND METHOD FOR CONDUCTING BUSINESS WITH A PAYMENT SOLUTION FOR BUYERS AND SELLERS which is hereby fully incorporated herein as though set forth in full.

### FIELD OF THE DISCLOSURE

The present disclosure relates to a system and method for conducting business through an electronic marketplace, and, more particularly, providing real time pricing based on variables related to a specific transaction.

### BACKGROUND

Current methods of conducting business are at times inefficient for both the buyer and the seller.

For example, businesses that sell goods or services oftentimes use a financing method known as factoring to receive immediate cash for their account receivables. Factoring requires the business to assign their accounts receivables to a factoring entity at a discount and the factoring entity is assigned the collection rights of the receivables. The discount applied to the receivables is dependent upon several variables, but it is not uncommon for the business to discount their receivables by 20% in exchange for immediate cash. Some businesses do not use factoring because the discount on receivables significantly reduces their profit margins. Therefore, for many businesses, factoring is not a cost efficient way to improve their cash flow. In addition, in a standard factoring situation, the risk of the buyer not paying rests with the seller. Further yet, a business that has made its receivables a security, cannot utilize factoring because the receivables are already pledged to a financial institution.

Businesses that purchase goods or services typically use a line of credit that is established with each seller. If the buyer deals with many sellers, the buyer must establish many lines of credit, which may negatively impact the buyer's credit worthiness. In addition, the tracking and payment of multiple invoices due become very burdensome, time consuming, and expensive for the buyer.

In the past, factoring and/or invoice finance companies have been concerned with the financial stability and quality of goods sold by the sellers. As time passed, and as technology has developed, factoring and invoice finance entities are more concerned with the financial details and the quality of the individual buyers of the seller's goods.

Therefore, there is needed is a cost efficient system and method for conducting business in an electronic marketplace.

### SUMMARY OF THE DISCLOSURE

The present disclosure is directed to a method for conducting business by utilizing an electronic marketplace, including assigning a fee structure and trade limit to a buyer for purchases made based on predetermined criteria, the buyer making selections of goods or services to purchase, and presenting the buyer a final price.

In another aspect, disclosed is a method for conducting business by utilizing an electronic marketplace, including assigning a fee structure and trade limit to a buyer for purchases made based on predetermined criteria, the buyer making selections of goods or services to purchase, and presenting the buyer a final price, the final price being determined by analyzing variables associated with the buyer.

In yet another aspect of the disclosure is a method for buyers and sellers to conduct business by utilizing an electronic marketplace, including a buyer establishing an account with a service provider by providing information, assigning a fee structure and trade limit to the buyer for future purchases made based on predetermined criteria, the buyer accepting the fee structure, storing the buyer's account information, including the fee structure, the buyer viewing a seller's electronic catalog which is either general or specific to the buyer, the buyer making selections of goods or services to purchase from the seller's electronic catalog, the buyer selecting payment terms for the goods or services selected, service provider or guarantor paying seller a net price for goods or services ordered by the buyer, and the buyer paying the service provider or guarantor a gross price for the goods or services ordered by the buyer.

Also disclosed is a system for buyers and sellers to conduct business utilizing an electronic marketplace, including a server system for executing system processes in communicating with at least one remote electronic device, wherein the server system includes a processor, coupled to memory and communicates with at least one remote electronic device over a communication interface, a registration process executable on the server system, the purchasing process comprising registering a buyer and allocating each buyer a unique pricing and financing fee structure, based on predetermined criteria, a purchasing price executable on the server system, the purchasing process comprising the buyer selecting and purchasing one or more products or services, with the purchase price, selection and payment options being based on the buyer's specific pricing and financing fee structure, and a selling process executable on the server system in response to the purchasing process.

### BRIEF DESCRIPTION OF THE DRAWINGS

The disclosure will now be described in greater detail with reference to the preferred embodiments illustrated in the accompanying drawings, in which like elements bear like reference numerals, and wherein:

FIG. 1 a schematic representation illustrating one embodiment of a system and method for buyers and sellers to conduct business in an electronic marketplace according to the present disclosure;

FIG. 2 is a block diagram illustrating an embodiment of a system configuration used to implement the present disclosure;

FIG. 3 is a block diagram illustrating an embodiment of the application software used to implement the present disclosure.

FIG. 4 is a schematic representation illustrating the relationships between the buyer, seller, service provider, and other parties according to the present disclosure;

FIG. 5 is a flow chart illustrating the buyer's account setup according to the present disclosure;

FIG. 6 is a flow chart illustrating the seller's account setup according to the present disclosure;

FIG. 7 is a flow chart illustrating the process of the buyer placing an order according to the present disclosure; and

FIG. 8 is a flow chart illustrating order fulfillment and payment according to the present disclosure.

### DETAILED DESCRIPTION OF THE DISCLOSURE

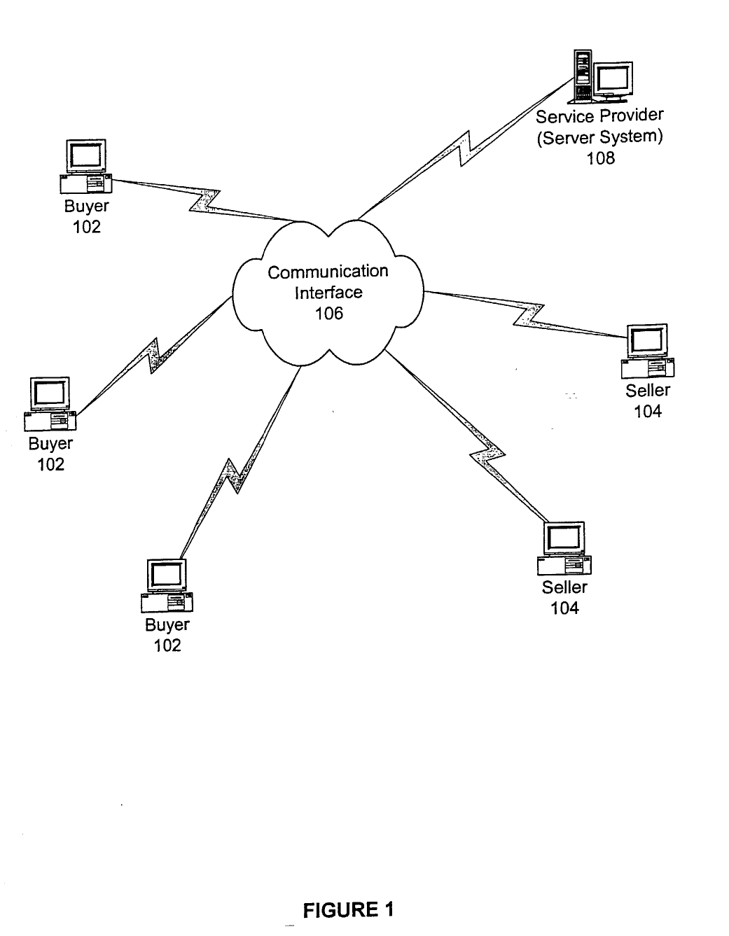

FIG. 1 illustrates one example of an operating environment for an electronic marketplace for buyers and sellers according to the present disclosure. The electronic marketplace disclosed could be used for the sale or exchange of any goods or services, but it is particularly useful when sellers desire a guaranteed payment for goods or services sold from a service provider and when buyers desire to use one line of credit for the purchase of goods or services from multiple sellers. The buyer only uses one line of credit when making purchases through the service provider, even when making purchases from multiple sellers. Therefore, the present disclosure allows the buyer to avoid accessing other existing lines of credit, which increases the buyer's overall financial position since other credits are available. The present disclosure provides an invoice and payment solution which enables a factoring entity, invoice finance companies, and others to price goods and services and to allocate trading or credit terms based on each individual buyer and each individual transaction based on one or more variables. The variables may include, as further disclosed below, the buyer's creditworthiness or potential purchasing volume or the seller's cost structure, including fees for conducting the transaction or desired profit or loss for a particular sale.

The present disclosure also provides additional advantages to smaller and individual buyers by allowing individual buyers to make purchases from larger sellers. In the past, larger sellers did not sell to individual buyers because it was cost and risk prohibitive. For example, the administrative costs, such as invoicing and collections and bad debts, would oftentimes negate any profit. Also, smaller buyers typically do not have access to larger sellers because of minimum purchase requirements, lack of a sufficient credit rating, or overall lack of purchase power.

All of these past shortcomings of the individual or smaller buyer are overcome by the present disclosure since the service provider handles the administration of the account for the seller and provides the buyer with a line of credit.

The present disclosure also provides many benefits to the seller. In the past, there has not been a cost efficient means for penetrating the market of smaller or individual buyers because of the administrative costs, logistical constraints, and financial risks associated with smaller or individual buyers. The present disclosure, however, removes these burdens since the service provider administers the accounts, issues the invoices to the buyer, issues the line of credit to the buyer, and is the guarantor of payment to the seller. Therefore, the present disclosure allows large sellers to efficiently and effectively penetrate the market of smaller and individual buyers without risk of default of the buyers. This market penetration is advantageous to sellers since collectively, the market of smaller and individual buyers is very large.

The present disclosure also provides that when the buyer makes a purchase from the seller, the account receivable created is owed by the service provider to the seller and is guaranteed by either the service provider itself or a guarantor such as a financial institution on its behalf with the option of receiving advance payment from the service provider. This guaranteed account receivable could be subject to an existing or new pledge by the seller of its receivables to a financial institution as a secured interest since it represents a new debt owed/secured by the service provider. This is contrary to existing business practices where such a seller making numerous individual sales to buyers cannot factor their accounts receivable to secure a guaranteed payment or advance payment from a factoring company because their receivables may have already been pledged to a financial institution.

Therefore, according to the present disclosure, the system includes remote computers 102 and 104 that are electronically connected to a communication interface 106. The remote computers 102 are used by buyers, and remote computers 104 are used by sellers. In the alternative, any electronic device could be utilized with the present disclosure. Therefore, implementation of the present disclosure does not require the use of remote computers or computers in general. Other electronic devices could be utilized in the implementation of the electronic system and method disclosed, such as mobile communication devices, including, for example, cellular telephones and PDAs. The use of the words remote computers herein is not intended to limit the disclosure, but only to describe an implementation of the system and method disclosed herein.

The remote computers 102 and 104 communicate with a service provider 108 through the communication interface 106. Alternatively, the service provider's software program can be loaded on computers 102 or 104. The communication interface 106 allows for the sending and receiving of data by the remote computers and the server system. In one implementation, the communication interface 106 is the Internet. The Internet is a global network of computers referred to as servers which are accessible by remote computers, often referred to as “user nodes” or “client computers.” These remote computers typically access the Internet through Internet Service Providers (ISPs), On-line Service Providers (OSPs), or direct Internet connections.

In another implementation, the communication interface 106 is a wireless based system such as cellular based, digital cellular, or other related wireless communication system.

In each implementation example, the remote computers 102 and 104 allow users to send data to and receive data from the server system 108 over the communication interface 106. The remote computer may be a personal computer, a laptop, a handheld computer, a PDA (Personal Digital Assistant), a server system, a workstation, a mobile phone, a wireless device, or other related devices containing a processor coupled to memory.

The server system 108 provides for executing system processes and communicating with remote computers over the communication interface 106. The server system 108 is configured to have one or more servers along with peripheral components. The servers can be configured as a client/server, web server, mainframe, or a supercomputer.

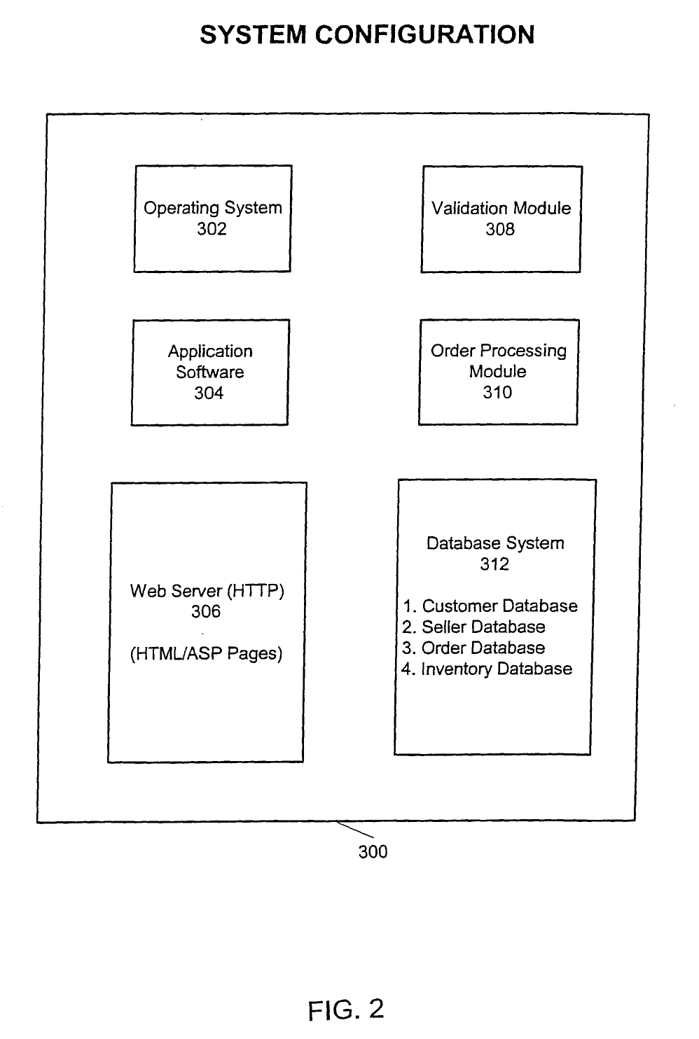

In one implementation example, the server system 108 is a web server, and the server system 108 receives an http request from a remote computer 102 (e.g., buyer) over the communication interface 106. The server system 108 responds to the request with an http response in the form of a web page. The remote computer 102 receives the web page for further review and processing. The server system 108 also includes software necessary for executing system processes, interfacing with the communication interface, and communicating with the remote computers as will be further discussed and illustrated in FIG. 2.

FIG. 2 is a block diagram of an implementation example of the system configuration for a server system of service provider 108. The server system 300 includes an operating system 302, application software 304, web server (http server) 306, validation module 308, order processing module 310, and a database system 312. The operating system 302 must be compatible with the type of server system used, such as whether a client/server configuration or a mainframe configuration is used. The operating system controls all system operations and processing of requests to the server system for the software and/or hardware devices. The web server 306 is a program that runs on the server system that allows for processing requests from the World Wide Web and allows for responding to the requests in the form of web pages. However, the software used to facilitate the present disclosure may be used on the buyer's computer, the seller's computer, or the service provider's computer or server.

For example, after the buyer places an order within their computer, the web server 306 receives and processes the order from the buyer. The order processing module 310 is initiated and receives the order information. The order processing module 310 passes the order information to the validation module 308 to verify elements of the order including the financial arrangements, fee structures, product availability, and other related elements. The validation module 308 verifies the order information against information contained in the database system 312 including a customer database, a seller database, an order database, and an inventory database. The validation module 308 by itself, or in combination with the order processing module 310, may retrieve verification information from other server systems or remote computers. Once the order is validated, the order processing module 310 processes the order by generating the notifications to the parties.

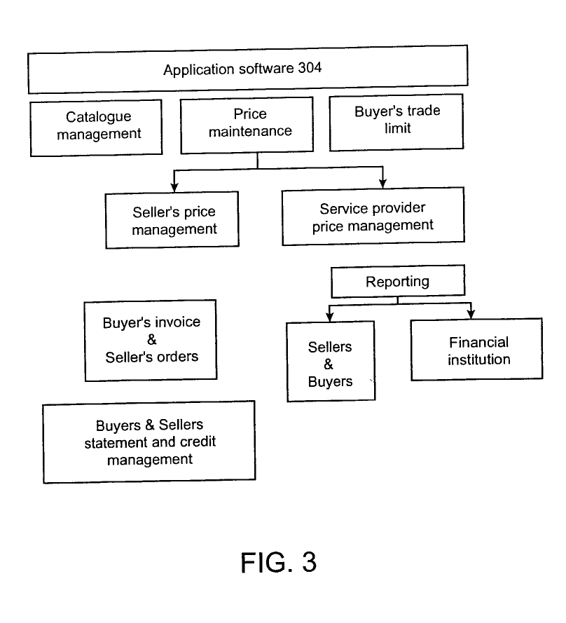

One example of the application software is illustrated in FIG. 3. The application 304 includes several modules, including a catalog management module that lists all of the items in the electronic catalog that are for sale for each seller utilizing the system. The application software also includes the buyer's trade limit information which includes the information of all of the registered buyers who have registered to utilize the electronic system. The application software also includes a price maintenance module which includes two sub-modules, including the seller's price management module and the service provider price management module. The application software also includes a reporting function for the sellers and the buyers and for the financial institution. The application software also includes software necessary to generate and store the buyer's invoices and the seller's orders, as well as the buyer's and seller's statements, and provide for a credit management function.

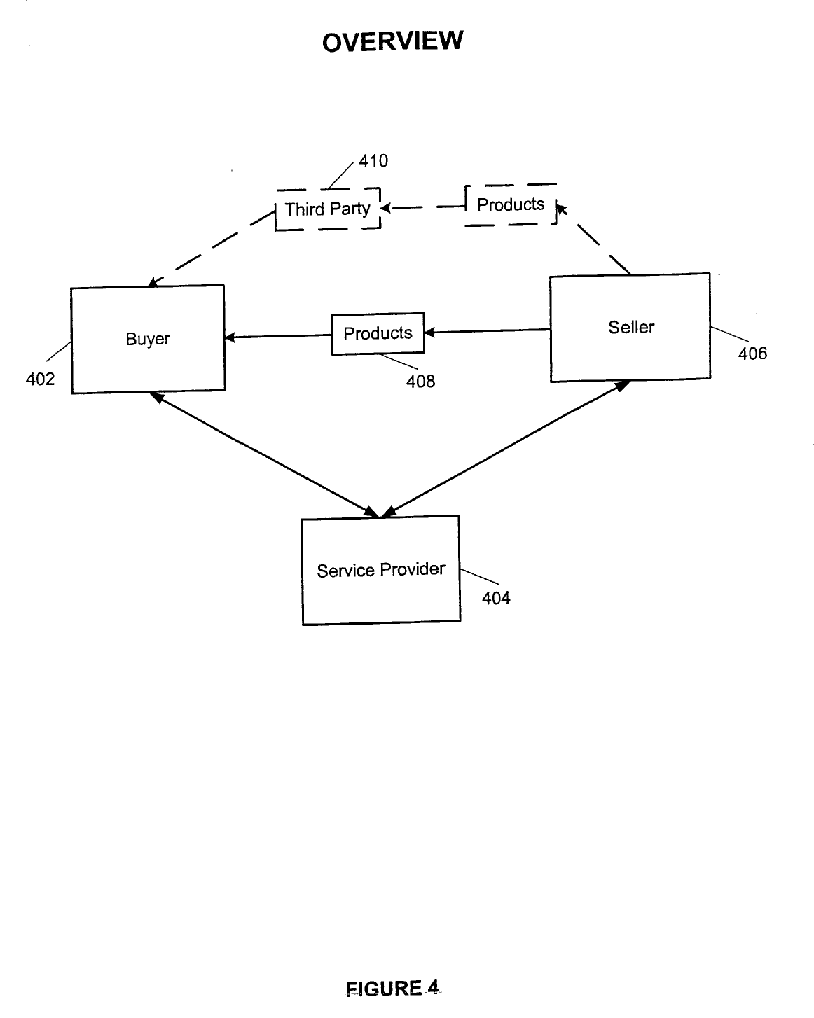

FIG. 4 illustrates an overview of the relationships between the buyer, the seller, the service provider, and other parties according to the present disclosure. The buyer 402 and the seller 406 communicate directly with the service provider 404. The Buyer 402 places the order with the Service Provider 404, and the products 408 are shipped directly from the seller 406 to the buyer 402 after the service provider confirms the order. In the alternative, seller 406 forwards products to a third party 410 who forwards the products to the buyer 402. The third party 410 may be a distributor, a repackager, or a shipping company who ships on behalf of seller 406. For example, a third party 410 would be utilized when the seller only sells certain lot sizes of products and the buyer has placed an order for an odd lot size. The third party would break down lots from the seller to accommodate the buyer's order. As will be further explained in more detail below, when the seller confirms dispatch of the goods to the service provider and the buyer, the service provider pays the seller all undisputed related buyer's invoices notwithstanding whether the buyer has paid the service provider or not. Therefore, the service provider separately, collects the payment from the buyer. The service provider 404 may obtain financial backing from a financial institution as required or desired. The service provider becomes liable for the debt and thereby acts as a guarantor of payment to the seller, but the guarantor may be a financial institution 412 in addition to the service provider's liability for payment to the seller.

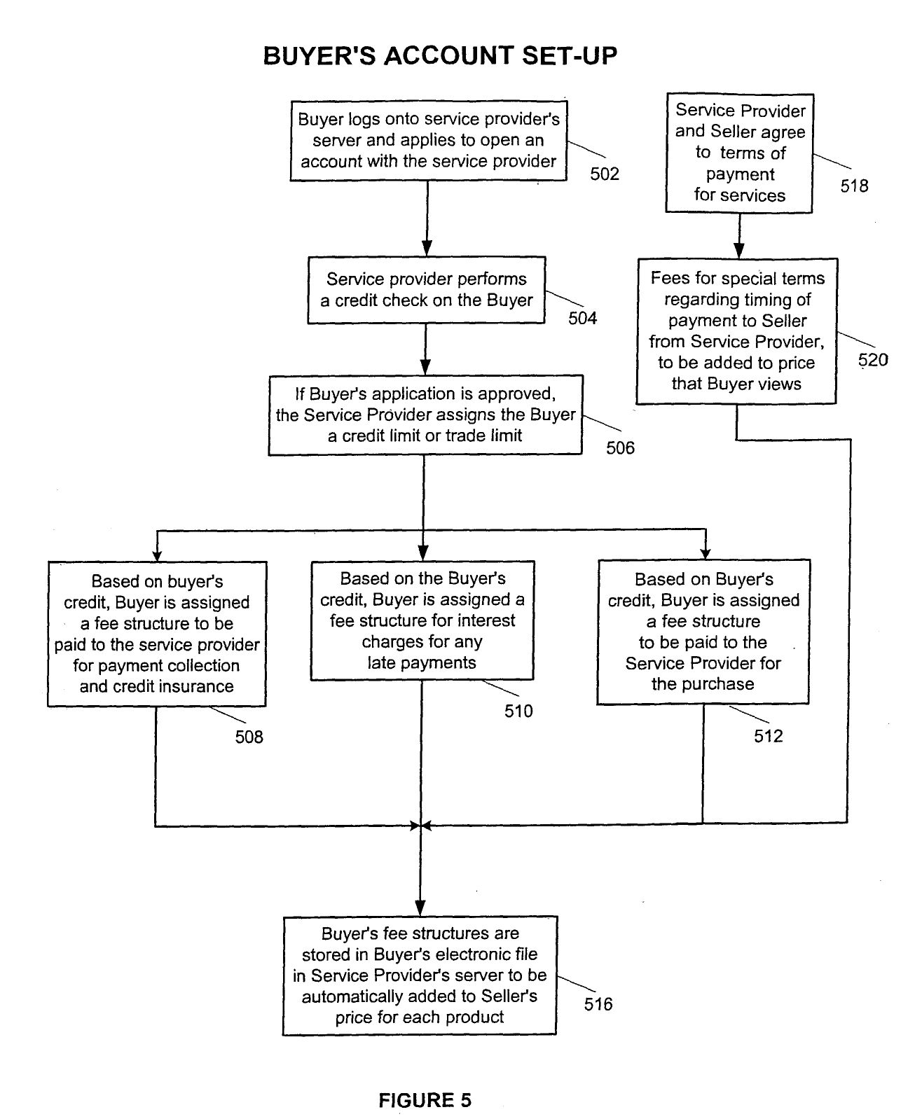

FIG. 5 illustrates the process of a buyer setting up an account with the service provider. At step 502 the buyer logs onto the service provider server via the communication interface and applies to open an account with the service provider. When the buyer applies to open an account with the service provider, the buyer provides certain information as requested by the service provider by filling out information on an online form. At step 504 the service provider performs a credit check on the buyer. This credit check may be conducted by the service provider, or the service provider may forward the buyer's information on to a third party to perform the credit check and report the results back to the service provider. The credit check may be done manually or may be done electronically. At step 506, if the buyer's application is approved, the service provider assigns the buyer a credit or trade limit based on the buyer's creditworthiness or credit rating.

Based on predetermined criteria, such as the buyer's creditworthiness, purchasing volume, or other criteria, the service provider assigns a fee structure to the buyer for future purchases made by the buyer through the electronic marketplace. As shown in step 508, the buyer is assigned a fee structure that is to be paid by the buyer to the service provider for services provided including, but not limited to, payment collection and credit insurance. The assigned fee structure is generated by the server processing all the reported data. As shown in step 510, the buyer is also assigned a fee structure for interest charges for any late payments incurred by the buyer. Also, as shown in step 512, each buyer is assigned a fee structure or commission that is to be paid to the service provider by the buyer with the purchase of the goods or the services. The fee structures may either be a flat fee, subscription fee or a commission that represents a percentage of the purchase made by the buyer or may be a commission added to the seller's price of each product or service. Other fee structures may be assigned as well. For example, once the service provider and seller agree to terms of payment for services as shown in step 518, the seller assigns a fee as shown in step 520 for buyer's special terms of payment, such as if the buyer wishes to pay for the goods in 30, 60, or 90 days. As will be further described below, based on the buyer's selection, the special terms of payment are added to the inclusive price viewed by the buyer. This inclusive price may also be referred to as a final price that includes the price for the goods or services and the fees for the transaction for the specific buyer and for the specific transaction. The buyer's fee structures assigned in steps 508, 510, 512, and 520 are combined into one inclusive fee structure and at step 516 are stored in the buyer's electronic file in the service provider's server to be automatically added to seller's price for each product for the particular buyer. These fees can be charged per each transaction, added to each product or may be based on any other method.

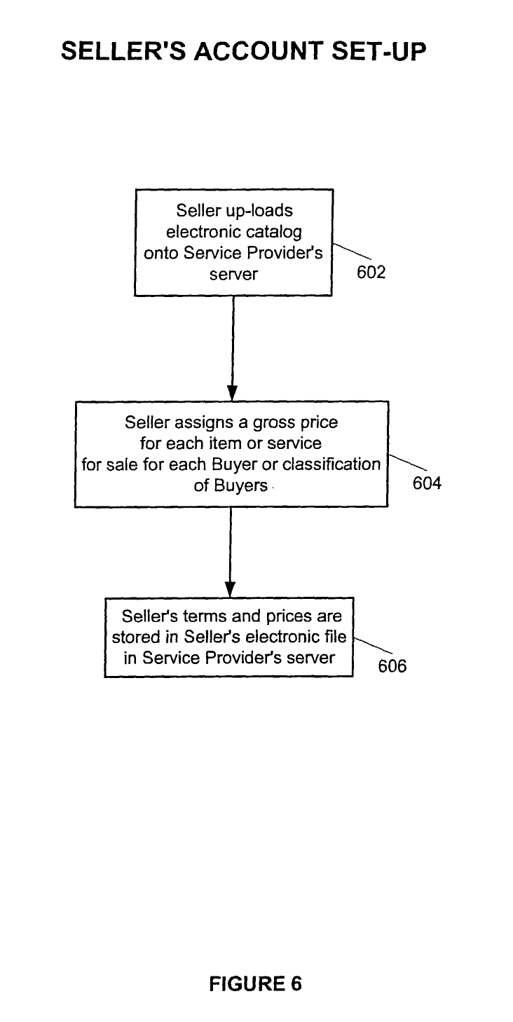

FIG. 5 and FIG. 6 illustrate the process of the seller setting up the seller's account. At step 518 the service provider and seller agree to the terms of payment for the services provided by the service provider. At step 520 the special terms of payment are established with the service provider relative to the buyers' and the service provider's payment terms. As shown in step 602, the seller uploads the seller's electronic catalog onto the service provider's server. As shown in step 604, the seller assigns a net price for each item or service for sale for. each buyer, classification, or category of buyers, which is ultimately reflected as a gross price when viewed by the buyer. In addition, the seller may load several catalogs and several different price lists for different buyers. The gross price includes all fee structures assigned to each particular buyer or each classification or category of buyers so that when a buyer is viewing the seller's electronic catalog, the buyer views an all-inclusive gross price including all fee structures to be paid to the seller and the service provider. The classification of buyers may include, for example, bulk retailers, discount retailers, wholesalers, independent retailers, or any hybrid thereof. At step 606 the seller's terms and prices are stored in the seller's electronic file in the service provider's server. The price revealed to the buyer is a real time reflecting the cost of goods based on the particular transaction and possibly a dynamic price based on the seller's price at the time of the transaction.

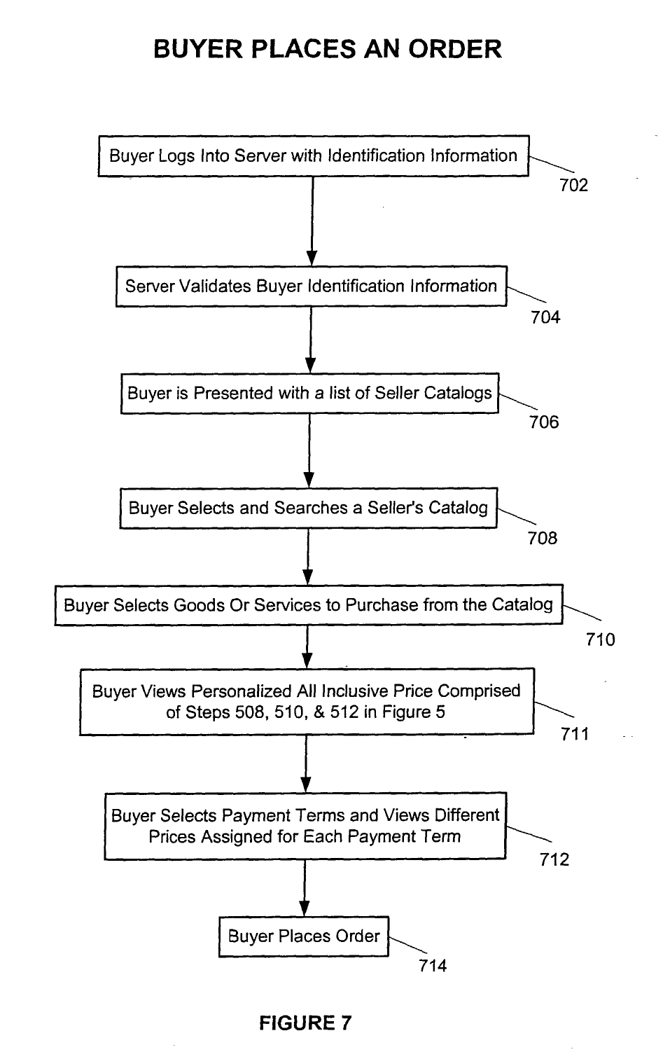

FIG. 7 illustrates the process of the buyer placing an order, wherein at step 702 the buyer logs into the service provider's server by providing identifying information. At step 704 the service provider's server validates the buyer's identification information, allows the buyer access to the service provider's server, and allows the buyer to view preassigned products and prices. In the alternative, the server system is maintained and operated by the seller. In this situation, the buyer logs onto the seller's server.

At step 706 the buyer is presented with a list of seller's catalogs. At step 708 the buyer selects and searches the seller's catalog to view only the goods, prices, and service offered for sale by the seller to this specific buyer. At step 710 the buyer selects goods or services to purchase from the seller's electronic catalog. At step 711, the buyer views an all inclusive, personalized, price including fee structures from steps 508, 510, and 512. At step 712 the buyer selects payment terms, such as payment within 15, 30, 60 or 90 days upon receiving the invoice and a final price is presented to the buyer. The final price, in the alternative, may not include the additional terms. At step 714 the buyer places an order. The buyer may then view another seller's catalog and place additional orders. The buyer may place another order from the same seller but selecting different terms of payment or select a different seller or sellers while only accessing one line of credit or trade with the service provider.

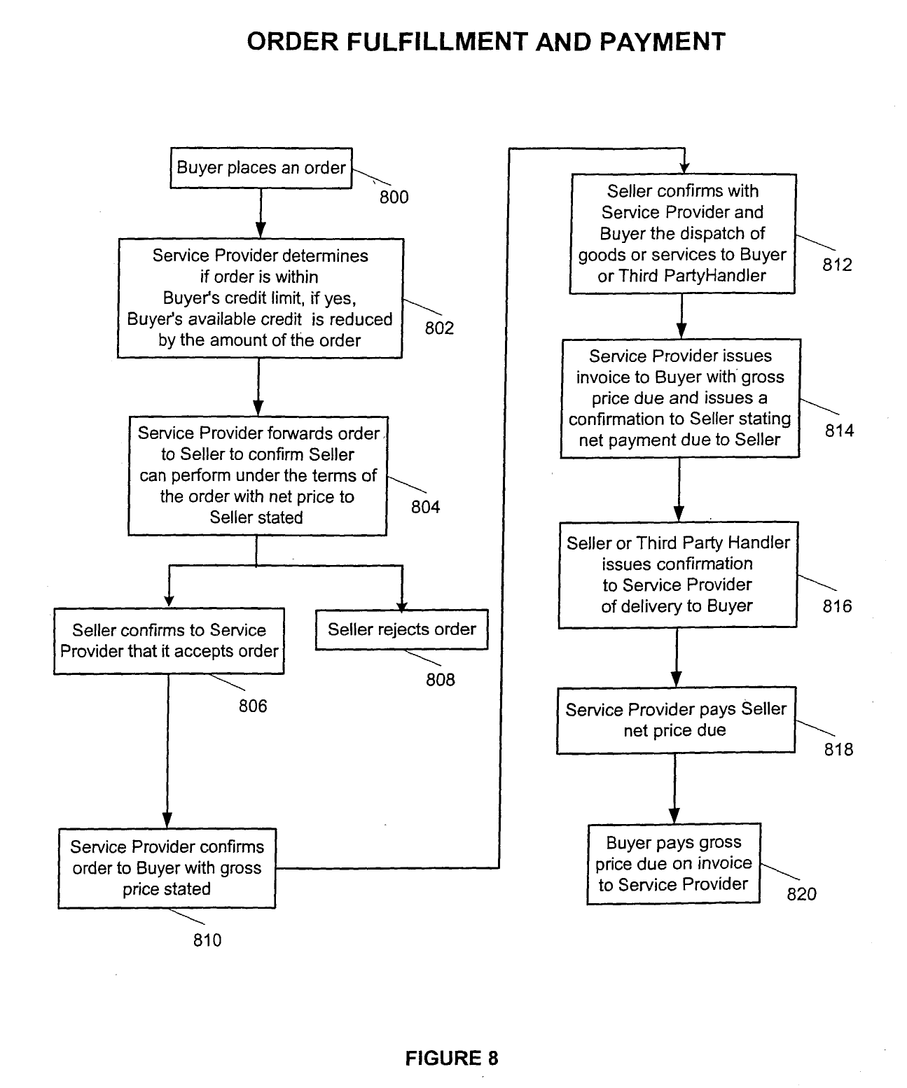

FIG. 8 illustrates the process flow after the buyer places his order 800. At step 802 the service provider determines if the buyer's order is within the buyer's credit limit. If the order is within the buyer's credit limit, then the buyer's available credit or trade limit is temporarily reduced by the amount of the order to be sure that the accumulation of outstanding orders will not exceed the trade or credit limit. The available credit or ability to trade within the agreed credit or trade facility is provisionally reduced and is actually reduced by the amount once the seller dispatches the order and the buyer is obliged to make the payment. However, once payment is made by the buyer, the credit is reinstated.

At step 804 the service provider forwards the buyer's order to the seller to confirm that the seller can perform under the terms of the buyer's order. The service provider forwards the order to the seller with both the net price to the seller stated and the gross price stated to the buyer. The net price excludes the fee structure to be charged to the buyer and only represents that amount that will ultimately be paid to the seller by the service provider. At step 806, the seller confirms to the service provider and the buyer that it accepts the buyer's order and that the seller will fulfill the order. In the alternative, at step 808 the seller rejects the buyer's order, and a message is sent to the buyer stating that his order has been rejected. If this is the case, the temporary reduction in the buyer's credit limit 802 is canceled and the buyer's account is reset. At step 810 the service provider confirms the buyer's order with the buyer with the gross price stated. The gross price includes all of the fees to be charged to the buyer per the previously agreed fee structure. At step 812 the seller confirms with the service provider and with the buyer the dispatch of the goods or the services to the buyer or to a third party handler. As shown in step 814, the service provider issues an invoice to the buyer with the gross price due stated and further issues a confirmation to the seller stating the net payment due to the seller. At step 816 the seller or a third party handler issues a confirmation to the service provider of the delivery of the goods or services to the buyer. At step 818 the service provider then pays the seller the net price due for the goods or services sold. The payment is made from the service provider to the seller of all undisputed related invoices relating to the buyer even though the buyer has not yet paid for the goods or services ordered. At step 820 the buyer pays the gross price due on the invoice to the service provider and the buyer's credit or trade limit is reinstated.

Any of the methods may be tangibly embodied as a series of instructions stored on a processor readable medium. These instructions may exist independently, or they may be stored on a processor readable medium or memory. The medium may be part of the system including a processor configured to access the medium. Also, any of the methods may be tangibly embodied on a client or server. The electronic marketplace system as produced by any of the methods discussed may be embodied in the form of data or data structures. These data or data structures, as the case may be, may exist independently, or they may be, stored in a memory or a computer readable medium including, without limitation, a hard disk, a floppy disk, RAM, ROM, EPROM, EEPROM, flash memory, volatile memory, read/write memory, CD-ROM, DVD, or any other related memory or computer readable medium.

Although this disclosure has been shown and described with respect to detailed embodiments, those skilled in the art will understand that various changes in form and detail may be made without departing from the scope of the claimed disclosure.

I claim:

1. A method for conducting business by utilizing an electronic marketplace, comprising:
assigning a fee structure and trade limit to a buyer for purchases made based on predetermined criteria;
the buyer making selections of goods or services to purchase; and
presenting the buyer a final price.

2. The method of claim 1, wherein the final price is real time price.

3. The method of claim 1, wherein the buyer is also presented with an electronic invoice.

4. The method of claim 1, wherein the final price includes service provider fees.

5. The method of claim 1, wherein the final price is determined in part by a computation of payment terms.

6. The method of claim 5, wherein the computation of payment terms includes the financial costs of the transaction.

7. The method of claim 1, wherein the final price includes the cost of credit insurance.

8. The method of claim 1, wherein the trade limit is a credit limit.

9. The method of claim 1, wherein the trade limit is based on invoice finance criteria.

10. The method of claim 1, wherein the final price is dynamically changed for each transaction according to several variables.

11. The method of claim 1, wherein the final price is determined by analyzing variables associated with the buyer.

12. The method of claim 1, wherein the final price is determined by analyzing variables associated with a specific transaction.

13. The method of claim 1, wherein the final price is determined, in part, by the buyer's credit worthiness.

14. The method of claim 1, wherein the final price is determined, in part, by the seller's cost of the goods or services at the specific time of the transaction.

15. The method of claim 1, further comprising the buyer viewing an electronic catalog and making selections from the electronic catalog.

16. A method for conducting business by utilizing an electronic marketplace, comprising:
assigning a fee structure and trade limit to a buyer for purchases made based on predetermined criteria;
the buyer making selections of goods or services to purchase; and
presenting the buyer a final price, the final price being determined by variables associated with the buyer.

17. The method of claim 16, further comprising the buyer viewing an electronic catalog and making selections from the electronic catalog.

18. The method of claim 16, wherein the final price is dynamically changed for each transaction according to several variables.

19. The method of claim of 16, wherein the final price is determined, in part, by the buyer's creditworthiness.

20. A method for buyers and sellers to conduct business by utilizing an electronic marketplace, comprising:
a buyer establishing an account with a service provider by providing information;
assigning a fee structure and trade limit to the buyer for future purchases made based on predetermined criteria;
the buyer accepting the fee structure;
storing the buyer's account information, including the fee structure;
the buyer viewing a seller's electronic catalog which is either general or specific to the buyer;
the buyer making selections of goods or services to purchase from the seller's electronic catalog;
the buyer selecting payment terms for the goods or services selected;
the service provider or guarantor paying seller a net price for goods or services ordered by the buyer; and
the buyer paying the service provider or guarantor a gross price for the goods or services ordered by the buyer.

21. The method of claim 1, further comprising:
checking the credit of the buyer when the buyer applies for the account; and the service provider or guarantor assigning a credit limit to the buyer.

22. The method of claim 20, wherein the fee structure is based on the buyer's creditworthiness.

23. The method of claim 20, wherein the fee structure includes fees to be paid to a guarantor of payment to the seller.

24. The method of claim 20, wherein the fee structure includes interest charges for payment terms.

25. The method of claim 20, wherein the fee structure includes fees to be paid to the service provider for a purchase.

26. The method of claim 20 wherein the fee structure includes fees to be paid to the service provider for each purchase.

27. The method of claim 20, further comprising:
the seller assigning a price for each item or service for sale to each particular buyer or classification of buyers.

28. The method of claim 20, further comprising:
service provider storing the seller's assigned prices for each particular buyer or classification of buyers.

29. The method of claim 20, wherein the gross price includes the fee structure to be paid by the buyer, and the net price excludes the fee structure to be paid by the buyer.

30. A system for buyers and sellers to conduct business, utilizing an electronic marketplace, comprising:
a server system for executing system processes in communicating with at least one remote electronic device, wherein the server system includes a processor coupled to memory and communicates with at least one remote electronic device over a communication interface;
a registration process executable on the server system, the registration process comprising registering a buyer and allocating each buyer a unique pricing and financing fee structure based on predetermined criteria;
a purchasing price executable on the server system, the purchasing process comprising the buyer selecting and purchasing one or more products or services, with the purchase price, selection and payment options being based on the buyer's specific pricing and financing fee structure; and
a selling process executable on the server system in response to the purchasing process.

31. The system of claim 30, wherein the electronic device is a remote computer.

32. The system of claim 30, wherein the fee structure is based on the buyer's creditworthiness.

33. The system of claim 30, wherein the purchase price is determined by variables associated with a specific transaction.

34. The method of claim 1, wherein an account receivable is created and is paid by a service provider to the seller.

35. The method of claim 34, wherein the account receivable is guaranteed by the service provider.

36. The method of claim 34, wherein the account receivable is guaranteed by a third party.

37. The method of claim 34, wherein the account receivable is guaranteed by a financial institution.

38. The method of claim 1, wherein the account receivable is created and owed by a service provider or a third party to the seller.

39. The method of claim 1, wherein an account receivable is created and guaranteed by a third party, with an option for advance payment from a service provider.

40. The method of claim 39, wherein the guaranteed account receivable is subject to an existing or new pledge by the seller to a financial institution.

41. A computer readable medium that can be used to execute a computer program according to the method of claim 1.

42. A computer or data processor performing operations controlled by a software program to execute the method of claim 1.
